(19) United States
(12) Patent Application Publication
(10) Pub. No.: US 2003/0221409 A1
(43) Pub. Date: Dec. 4, 2003

(54) Pollution reduction fuel efficient combustion turbine

(76) Inventor: Thomas F. McGowan, Atlanta, GA (US)

Correspondence Address: Betty Formby, Carstens, Yee & Cahoon, PO Box 802334, Dallas, TX, 75380-2334, US

(21) Appl. No.: 10/157,214

(22) Filed: May 29, 2002

(51) Int. Cl. F02C 7/22

(52) U.S. Cl. 60/39.17; 60/734

(57) ABSTRACT

A combustion chamber in a combustion turbine is operated in a fuel rich mode, so that combustion is incomplete in the combustion chamber. Additional air can be added either in the expansion turbine or in additional combustion chambers, with additional combustion taking place either in the expansion turbine or in the additional combustion chambers. The process is better able to maintain a steady temperature throughout the expansion turbines, achieving higher efficiencies and more nearly approximately the more efficient infinite reheat cycle than the simple Brayton cycle. The atmosphere at the exit to the combustion chamber is reducing, rather than the normal oxidizing atmosphere, so oxidation of nitrogen to produce NOₓ is lessened, and the ability to use other alloys is enhanced. Emissions of CO₂, a greenhouse gas, are reduced per unit of power produced.

### BACKGROUND OF THE INVENTION

1. Technical Field

The present invention relates to combustion turbines, and more particularly to utilizing a combustion turbine in a manner that both is fuel-efficient and creates the least amount of pollution.

2. Description of Related Art

In the United States, combustion turbines are the technology of choice for new power plants. A simplified version of an exemplary combustion turbine is shown in FIGS. 1A and 1B. In its very basic form, a combustion turbine 100 has three sections: a compressor 110, a combustion chamber 120, and a turbine 130. Although these are shown in the diagram as separate pieces, it should be understood that these parts together form a sealed, gas-tight system. Looking inside the combustion turbine, the compressor 110 and the expansion turbine 130 contain many rows of small airfoil-shaped blades 122, 132 arranged in stages, a stage being a row of rotating blades (rotors) followed by a row of stationary blades (stators) for a compressor and a row of stator blades followed by a row of rotor blades for a turbine 132. The stages are in series and each contributes to the pressure rise in a compressor and to a pressure drop in a turbine. The rotating blade rows are connected to each other by a shaft 150 that runs through the compressor 110, combustion chamber 120, and expansion turbine 130. The rotating rows of blades are connected to the inner shaft and rotate at high speed, while the stationary rows are attached to the outer shell. The compressor 110 takes in ambient air; the rotor blades 122 force the air into a narrowing volume, compressing and heating the air as it moves through. In the combustion chamber 120, fuel is injected into the air stream and ignited. The burning fuel causes the gas to expand in volume, the gas is forced through the expansion turbine at a very high velocity 130, where it turns the expansion turbine rotors 132, expands and exits at the outlet of the expansion turbine 130. The expansion turbine rotors 132 turn the shaft 150 that drives the compressor 110 at the front of the combustion turbine 100, as well as a generator or other load. Energy that is not necessary to maintain the compression of the input air and is not lost in the outlet gas is available to do outside work, such as generating electricity. The efficiency of a combustion turbine can be determined by the percentage of the total heat input as fuel that is available for work outside the turbine. For instance, if approximately 70 percent of the total heat input is required to compress the air or is lost in the outlet gas, while 30 percent is available for work outside the combustion turbine, the combustion turbine is 30% efficient. This is a typical efficiency for a simple cycle turbine that does not have recovery of waste heat on the back end.

One common mechanism of increasing efficiency is to utilize multiple compressors and/or expansion turbine, rather than the single compressor and expansion turbine shown. In a high pressure ratio engine such as that used in some aircraft jet engines, efficiency is increased via the use of a high pressure ratio, and multiple compressors and expansion turbines, called spools may be used in series to generate these high pressures. In FIG. 2, a first compressor 210A performs the initial compression of air, while compressor 210B compresses the air even further. Higher pressures reduce the size of the expansion turbine inlet stage and increase efficiency. The compressed air is then introduced into the combustion chamber, where the fuel is injected and burned. The gases exit the combustion chamber and pass through the high pressure expansion turbine 130 which extracts enough energy to drive the high pressure compressor 210B. The gasses then pass through the intermediate pressure turbine 130′, which drives the low pressure compressor, 210A and finally through the low pressure or power turbine 130″ which drives the load.

Other means of increasing efficiency include the use of regenerators or intercoolers. FIG. 2B shows a turbine 200 in which the compressor 210 has a low-pressure ratio, i.e., there is only moderate air compression. A regenerator or heat exchanger 270 can capture some of the heat in the exhaust gas from the expansion turbine 230, using it to pre-heat the air entering the combustor 220 to reduce fuel input and raise efficiency.

FIG. 2C shows a high-pressure ratio turbine 200′ in which the compression of the gases can raise the temperature too high for the physical limits of the metals used in the compressor and/or the high compressed air temperatures raise compressor power requirements. In this example, a low pressure compressor 210′ is followed by an intercooler 280, which removes excess heat before the air is further compressed in a high pressure compressor 210″. Such intercooling is frequently used in conjunction with regenerators.

Another means of increasing engine efficiency is to reheat the gas in the expansion process after it has expanded part way through the turbine. If a large number of reheat steps are used, the process approaches an isothermal expansion thereby maximizing the temperature at which heat is added to the cycle and consequently improving thermal efficiency.

The ultimate current method of increasing efficiency in power generation is to use combined cycle power plants. That is a power plant that consists first of an intermediate pressure ratio combustion turbine driving a generator and the hot exhaust gasses from that combustion turbine are used as the heat source for a multi-pressure level steam bottoming cycle driving a second generator.

Controlling the temperature is very important to the operation of a combustion turbine and inlet and outlet temperatures affect the cycle efficiency. Thermodynamic cycles are a mathematical way to study processes that involve changes in heating and cooling cycles. For instance, the Carnot cycle is a theoretical cycle that consists of four successive reversible processes: A constant-temperature expansion with heat added to the system to cause the expansion, a further expansion after heating has stopped, a constant-temperature compression as the system cools, and a compression after cooling has stopped that restores the system to its original state. This is a hypothetical cycle that achieves ideal efficiency and is used as a standard of comparison for actual heat engine cycles.

Another thermodynamic cycle, the Brayton cycle, has long been considered the ideal practical cycle for the actual performance of a simple combustion turbine. This cycle consists of compression with no heat transfer (in the compressor), heating at constant pressure up to the temperature required (in the combustion chamber), expansion back to the original pressure (work is produced in the expansion turbine by this expansion, and temperatures decrease as pressure is reduced in the expansion), and cooling at constant pressure back to the original volume (this heat can be used in regeneration, directed to other uses, or lost).

The efficiency of any ideal thermodynamic cycle depends on the difference between the average absolute temperature at which heat is added in the cycle to the average absolute temperature at which heat is rejected from the cycle. Therefore, in the Brayton cycle, the highest efficiency will be achieved by a high temperature of the gases as they leave the combustion chamber 120 to expand and perform work in the expansion turbine 130. The limiting factor is the metallurgy of the first stage expansion of the turbine and blades, which cart be damaged by too high a temperature.

To achieve the highest efficiency without damaging equipment, current combustion turbines use a lean mix of fuel to air (i.e., a high amount of excess air) to limit the temperature of gases exiting the combustion chamber to a level compatible with stator and rotor material. Gas temperatures fall steadily from the point where they enter the expansion turbine to the point where they exit, hence thermodynamic efficiency falls also with each succeeding stage. The combustion chamber can only be run at higher temperatures if the rotors and stators can be cooled. This is being achieved by the introduction of steam, water, or additional air via porous rotor and stator surfaces at the entrance to the expansion turbine. This has the disadvantage, however, of reducing the gas temperature and adding mass to the process without adding heat.

Looking at the broad picture, one of the two primary issues with the use of combustion turbines for power generation is the cost of the fuel they require. It is estimated that for an average gas turbine life of 25 years, 70-85 percent of the cost of operating the turbine is the cost of fuel (Perry's Chemical Engineer's Handbook, 7^{th} ed, McGraw-Hill, N.Y., 1997). Therefore, fuel cost is a critical factor in the economics of combustion turbines, and even a small percentage savings is of paramount importance. For example, being able to run a combustion chamber at a slightly higher temperature can save millions of dollars a year.

The other primary issue with combustion turbines is the pollution they create, with much current concern both with the production of nitrogen oxides (NOₓ) and carbon dioxide y(CO₂), a “greenhouse” gas that promotes global warming. Nitrogen in the air is generally considered to be inert, but at the temperatures used in a combustion turbine (e.g. several thousand degrees), it will combine with oxygen to form oxides. One strategy in natural-gas-fired combustion turbines is to use specialty combustion chambers that premix a lean mixture of fuel prior to injection into the combustion chamber. Another strategy is to have an early portion of the chamber using a rich flow of fuel, with the fueVair mixture becoming leaner further along in the chamber. Some technologies, such as dry-low NOₓ firing, achieve NOₓ emissions less than 10 ppm on natural gas. NOₓ concentrations below this may require use of expensive catalysts and injection of ammonia or urea downstream of the expansion turbine.

Carbon dioxide (CO₂) is an end product of the combustion of any carbon fuel with oxygen and cannot be eliminated from the process, so efforts in this direction are aimed primarily at improving the efficiency of the process, so that more energy is produced from each unit of fuel burned. Happily, this aim is congruent with the need to keep fuel costs low by maximizing energy efficiency.

In summary, the current aim in combustion turbines is to achieve further efficiencies in the power produced from a given quantity of fuel. This would reduce fuel consumed, which in turn reduces fuel cost, CO₂ emissions per unit of power produced, and flue gas volume. This must, however, be achieved with no increase in NOₓ emissions, and preferably with a decrease.

### SUMMARY OF THE INVENTION

In the invention, fuel is injected into the combustion chamber of a combustion turbine under fuel rich conditions, e.g., at 50% of stoichiometric air (the air necessary to completely bum the fuel). The gases leaving the combustor will contain unconsumed fuel, such as CO, H₂, CO₂, N₂, H₂O, CH₄, other hydrocarbons and other compounds and elements. The fuel/air ratio is set so that the products of combustion leaving the combustion chamber are at or below the maximum temperature allowed by expansion turbine metallurgy. After the hot gases enter the expansion turbine, air is injected into the expansion turbine stages or in additional combustion chambers between expansion turbine stages to allow combustion of unconsumed fuel. The heat liberated by the combustion raises the temperature of the gases, in opposition to the cooling caused by the expansion of the gases. These opposing processes would allow operation approaching constant temperature conditions, so that thermal efficiency remains approximately the same from stage to stage. Hence this process approaches the isothermal expansion possible with the Carnot cycle, which is the most efficient thermodynamic cycle possible. This would result in higher overall efficiency in the power produced per volume of fuel. At the same time, the low concentration of oxygen, in relation to the fuel to be consumed, would mean that little oxygen was available for reaction with nitrogen to form undesirable NOₓ. The mass of exhaust gases would also be decreased in this process as compared to normal excess air firing.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIGS. 1a and 1b show simplified diagram of the parts of a basic combustion turbine.

FIGS. 2a, 2b, and 2c show variations on a basic combustion turbine that can increase efficiency.

FIG. 3 shows a combustion turbine according to a first embodiment of the invention.

FIG. 4 shows a combustion turbine according to a second embodiment of the invention.

FIG. 5 shows a combustion turbine according to a third embodiment of the invention.

FIG. 6 shows a combustion turbine according to a fourth embodiment of the invention.

FIG. 7 shows a combustion turbine according to a fifth embodiment of the invention.

FIG. 8 shows a combustion turbine according to a sixth embodiment of the invention.

FIG. 9 shows a graph of the temperature of a burning fuel plotted against the air-to-fuel ratio.

FIG. 10 shows a graph of the NOₓ emissions of a burning fuel plotted against the air-to-fuel ratio.

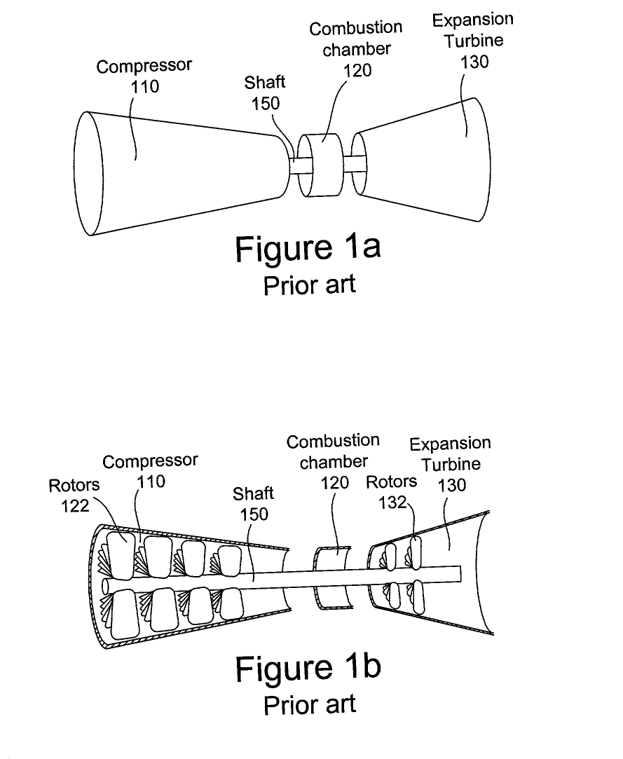

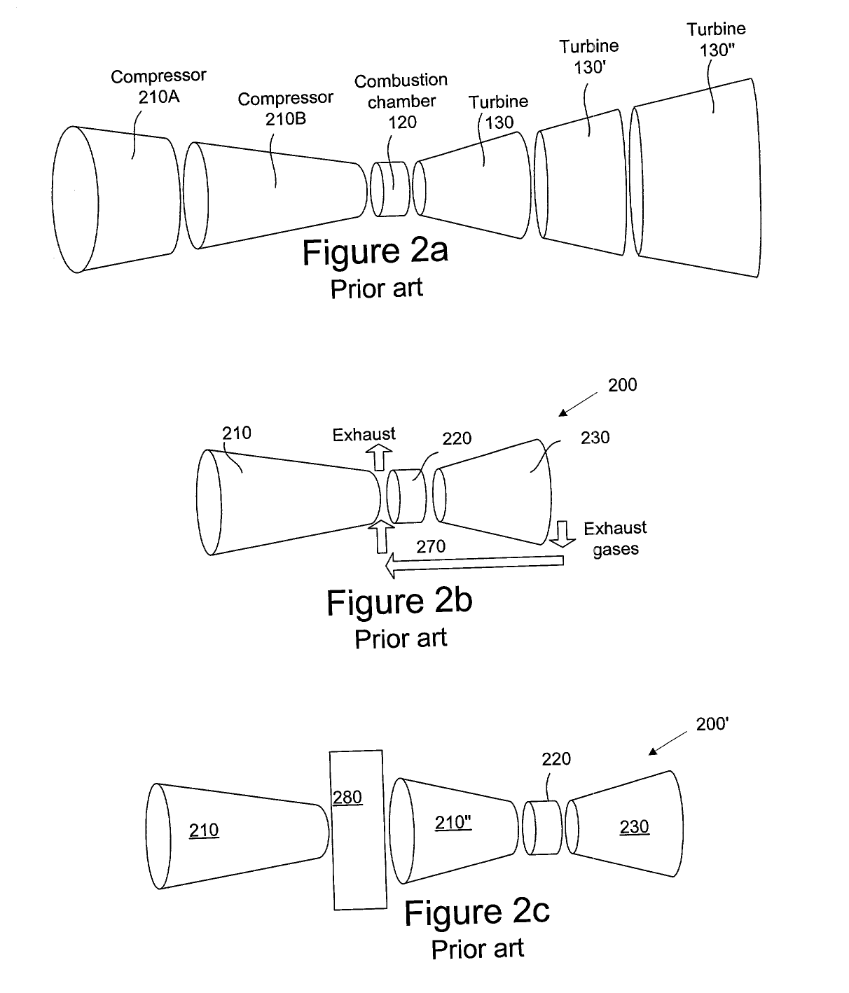

### DETAILED DESCRIPTION

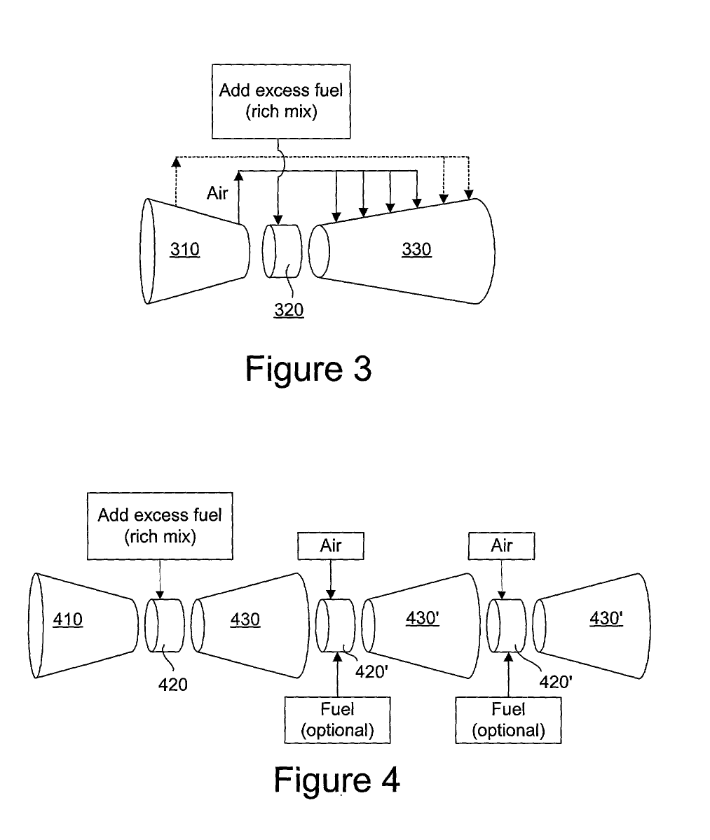

The invention will now be described with reference to FIGS. 3-10. In the first version of the invention shown in FIG. 3, substoichiometric firing of fuel and air, also know as fuel-rich combustion, is used in the combustion chamber 320 to limit the temperature of the gas entering the expansion turbine 330. Then, the air that is injected to cool the rotors and stators is used to complete combustion of the fuel. The gases leaving the combustion chamber will contain CO, H₂, CO₂, N₂, H₂O, CH₄, other hydrocarbons, and other compounds and elements. These will combust in the incoming oxygen, reheating the gases, while at the same time the gases continue to expand and cool in the expansion turbine. The fuel/air ratio is set so that the gases leaving the combustion chamber is at or below the maximum temperature allowed by the metallurgy of the expansion turbine parts. The air injected into the expansion turbine can be taken off from early stages of compressor 310, as shown by the dotted lines in the figure, to reduce compressor power, or later stages of the compressor, as shown, although the air may also come from other sources. There can be multiple points at which air is injected, in order to prolong combustion as the fuel moves through the expansion turbine. Steam or atomized water may be injected into the combustion process for cooling. Adding steam allows more air to be used and the water will react with carbon to produce more H₂ and CO. The process shown would allow operation approaching isothermal conditions, rather than having temperature and thermal efficiency drop from stage to stage. The higher temperatures in the later expansion stages would produce efficiencies above those previously reachable.

The substoichiometric firing prevents formation of NOₓ, as the available oxygen in the reaction will combine much more readily with the carbon and hydrogen in the fuel than with the nitrogen. This is in contrast to the prior art, where oxygen is in abundance, due to the deliberately lean fuel mixture. Table 1 below shows a direct relationship between available oxygen and the formation of NOₓ. This table shows equilibrium calculations for the reaction of nitrogen with oxygen when the available oxygen is varied, based on 2400° F. (1316° C.), and starting amounts of 3.76 kmole nitrogen and 0.0001 kmole oxygen. Note the dramatic change in NOₓ produced as more oxygen is added. Note particularly that NOₓ concentrations are given in parts per trillion, rather than the parts per million that prior art combustion turbines achieve. By eliminating the availability of oxygen in the combustion chamber and expansion turbine, an equally dramatic reduction in NOₓ can be realized.

| Oxygen Concentration, vol % | NOₓ concentration, vol | |
|---|---|---|
| 0.0026% | 0.0014 | parts/trillion |
| 2.6% | 1.3 | parts/trillion |
| 9.6% | 4.0 | parts/trillion |
| 15.7% | 50.0 | parts/billion |
| 21.0% | 50,000.0 | parts/billion |

| | |
|---|---|
| (normal ratio of N₂:O₂ found in air) | (divide ppt by 1,000 to |
| | convert to ppb) |

Additionally, by continuing combustion into the expansion turbine, a more constant temperature is realized and the process more nearly follows the more efficient multi-reheat cycle, rather than the simple Brayton cycle. Because of the increased efficiency of the process, less fuel is necessary to create the same amount of electricity, resulting in lower fuel costs and lower CO₂ emissions per unit of power produced.

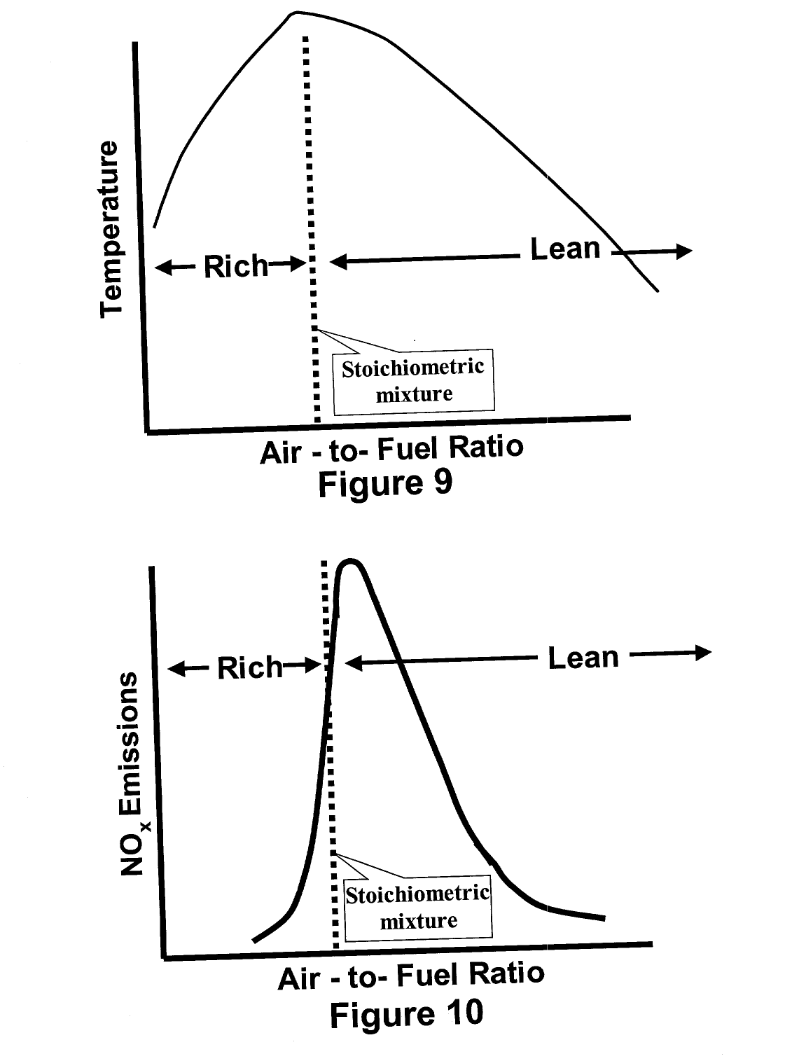

FIG. 9 shows a graph of the temperature of combustion measured against the air:fuel ratio. The left-hand side of the graph, where the ratio is low, is fuel rich; the right side of the graph is fuel poor, also known as lean combustion. FIG. 10 plots the formation of NOₓ against the same air-to-fuel ratio. In this graph, the level of emissions is at its peak when the mix is somewhat on the lean side, with the lower, more desirable levels of emissions when the mix is rich or else very lean. The NOx concentration starts to drop at low oxygen concentrations just to the right of the stoichiometric mixture line (in the region used in traditional LEA, or low excess air, firing), and drops off very rapidly as the mixture moves to the left of the stoichiometric line. FIG. 4 shows one alternate embodiment of the innovative method. In this embodiment, a rich mixture of fuel is added to the air coming from compressor 410 in the combustion chamber 420, but there is no attempt to cause combustion to continue in the expansion turbine 430. Rather, one or more additional combustion chambers 420′ are added between stages 430′ of the expansion turbines. The fuel mix is set to limit the temperature of the gas entering the expansion turbine, so that air is not needed to cool the rotor and stator. At each combustor 420′ additional air is added to burn more of the fuel, while the further expansion caused by the added heat produces work in expansion turbines 430′. Optionally, additional fuel could be added to the additional combustion chambers 420′. While the process is handled differently than in the prior example, the results, higher efficiency and lower NOₓ emissions, are the same.

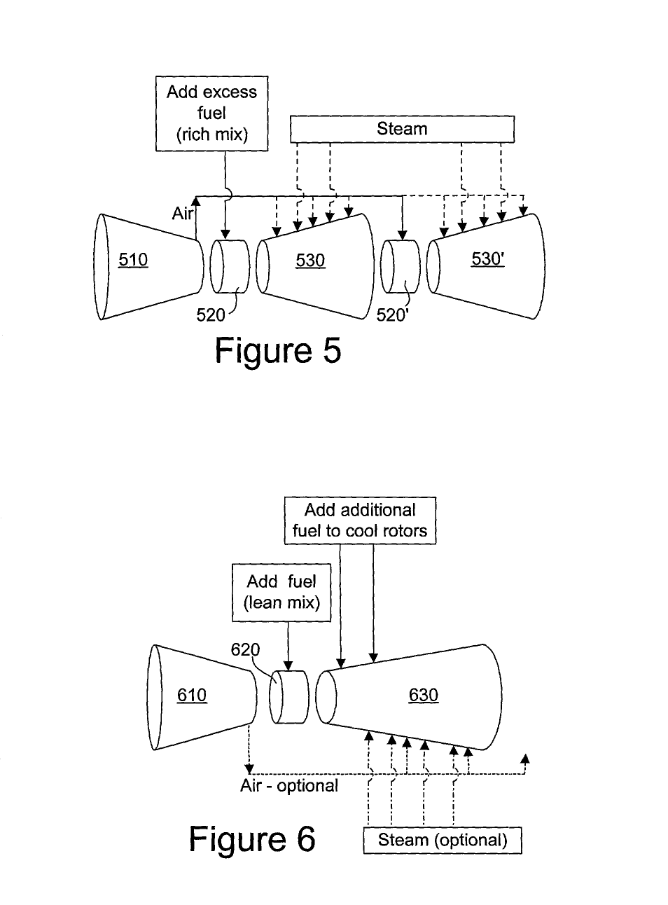

FIG. 5 shows a further embodiment of the invention. In this embodiment, excess fuel is added at combustion chamber 520 to create a rich mixture for burning. Air is then added in further combustors 520′ to complete combustion of the fuel. Steam can be injected into expansion turbines 530, 530′ to cool the expansion turbine and may react to produce hydrogen and CO. A combination of steam and air can also be injected into the expansion turbines 530, 530′. The second combustion chamber 520′ can be configured so that the air injected results in low excess air conditions to minimize NOₓ, or alternatively to inject air to result in higher excess air conditions which in turn limit temperature and limit thermal NOₓ.

FIG. 6 shows another alternate embodiment of the invention. In this embodiment, the fuel is added to combustion chamber 620 to form a lean fuel mix, as in the prior art, but fuel gas, or a mixture of air and fuel gas, is injected into the expansion turbine 630 to cool the rotor and stator, while providing fuel to combust with the excess air in the process. Air can be taken from compressor 610 and this air and/or steam can optionally be injected into the expansion turbine 630.

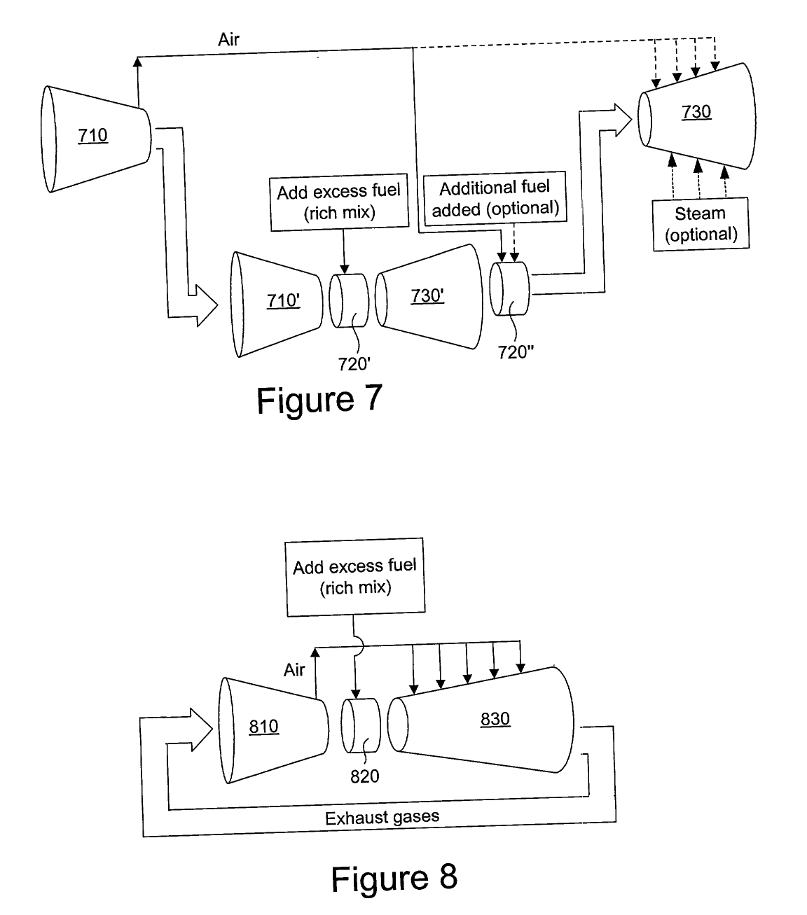

FIG. 7 shows another alternate embodiment of the invention. In this embodiment, the substoichiometric combustion chamber 720′ and expansion turbine 730′ are added as an auxiliary to an existing or new compressor 710 and expansion turbine 730. Air is taken off the existing compressor 710, then the pressure is boosted further in compressor 710′. After fuel is added in combustion chamber 720′ to make a rich mixture, combustion can optionally continue in expansion turbine 730′. Air is then added to an external combustion chamber 720″ downstream of the auxiliary expansion turbine outlet to complete combustion, and more fuel can optionally be added. Air and/or steam can optionally be injected into the auxiliary expansion combustion turbine 730′. The gases are then sent to existing combustion turbine 730 for final expansion. This would allow operation at high inlet pressures for the new expansion turbine and result in a very small turbine.

FIG. 8 shows another alternate embodiment of the invention. In this embodiment, the compressor 810, combustion chamber 820, and expansion turbine 830 are much as they were in the first embodiment shown in FIG. 3, except that a portion of the exhaust gases are recirculated back into compressor 810. This has the effect of reducing the oxygen level in the combustor 830 and therefore reducing NOx emissions.

The innovative combustion turbine can use measurements of temperature plus the concentrations of CO, O₂, or both CO and O₂, to control the combustion process. These measurements can be taken from the expansion turbine outlet gases, the gases inside the expansion turbine, the outlet of the primary, secondary, or later combustors, the outlet of a duct burner, or the outlet of a waste heat boiler burner.

There are many advantages that can accrue when using the innovative method of operating a combustion turbine. Since there is no need for excess air, the total flow of gases is decreased as compared to normal excess air firing. The lower availability of oxygen in this process allows higher nitrogen fuels to be burned, while still limiting NOₓ emissions. Alloys that cannot be used in present turbines because of the high temperatures (e.g., above 1,500° F.) in combination with an oxidizing atmosphere may be used in the non-oxidizing atmosphere of the substoichiometric firing technique to provide longer turbine life and may allow operation at higher temperatures. The fuel rich mixture of expanding gases allows the application of refractory metals such as alloys of tungsten, columbium and molybdenum. Additionally, higher rates of cooling air may be used with the substoichiometric firing technique in the hotter stages of the expansion turbine, raising fuel efficiency.

While the invention has been particularly shown and described with reference to the preferred embodiments, it will be understood by those skilled in the art that various changes in form and detail may be made therein without departing from the spirit and scope of the invention. Many variations will be obvious to one of ordinary skill in the art of combustion turbines. For example, just as in the prior art, intercooling and regeneration may be used with the innovative process to enhance fuel efficiency. Additionally, NOₓ reduction techniques, such as selective catalytic reduction (SCR) of NOₓ, selective non-catalytic reduction (SNCR) of NOₓ, and other post-combustion NOₓ control techniques, as well as CO reduction catalysts, and CO reduction via burning the expansion turbine exhaust gases in a waste heat recovery boiler burner or duct burner, can be used to further reduce emissions.

Details of combustion chambers have been omitted from this application, but it will be recognized that there are several types of combustors, such can-annular combustors, annular combustors, and external tubular combustor. The invention is not limited to any one type of combustion chamber, but is adaptable to any type.

Additionally, the invention has been described primarily in terms of combustion turbines used in power plants for the production of electricity. However, the invention is equally applicable to combustion turbines used for other purposes, such as in jet engines. The invention can also be used with a wide variety of fuels, including but not limited to gas, oil, hydrogen, synthetic fuels, coal-derived fuels, aviation fuels, and solid fuels or a combination of these fuels.

What is claimed is:

1. A combustion turbine comprising:
a compressor;
a first combustion chamber, connected at a first end to said compressor, said combustion chamber containing fuel injectors; and
a first expansion turbine, connected to a second end of said combustion chamber;
wherein said fuel injectors are connected to deliver a greater flow of fuel to said combustion chamber than there is available oxygen to bum said fuel completely.

2. The combustion turbine of claim 1, further comprising air injection ports in said expansion turbine, wherein said air injection ports are connected to deliver air at points within said expansion turbine.

3. The combustion turbine of claim 1, further comprising a second combustion chamber and a second expansion turbine, wherein said first expansion turbine contains ports for injecting air into said first expansion turbine.

4. The combustion turbine of claim 1, further comprising a second combustion chamber and a second expansion turbine, wherein said second combustion chamber contains ports for injecting air into said second combustion chamber.

5. The combustion turbine of claim 1, wherein said expansion turbine comprises materials that are acceptable for operation in a non-oxidizing, high-temperature atmosphere.

6. The combustion turbine of claim 1, wherein said expansion turbine is configured to receive fuel gas or a mixture of air and fuel gas.

7. The combustion turbine of claim 1, wherein said expansion turbine is connected to receive additional air.

8. The combustion turbine of claim 1, wherein said expansion turbine is connected to receive steam, water or atomized water.

9. The combustion turbine of claim 1, wherein said second combustion turbine is connected to produce low excess air firing to limit the amount of NOₓ that can be generated in the second combustion stage.

10. The combustion turbine of claim 1, further comprising a device to capture remaining heat in gases exhausted from said combustion turbine and to use captured heat to raise the temperature of gases prior to input to said combustion chamber.

11. The combustion turbine of claim 1, further comprising an intercooler, connected between stages of said compressor, said intercooler being connected to remove excess heat from air traversing said compressor.

12. The combustion turbine of claim 1, wherein a portion of said exhaust gas exiting from said expansion turbine re-circulates to said compressor intake to provide a lower oxygen level in said combustion chamber.

13. The combustion turbine of claim 12, where an after-cooler cools said portion of said exhaust gas that is recirculated.

14. The combustion turbine of claim 1, where gases leaving the first combustion chamber are routed through a pressurized steam boiler before entering the expansion turbine and fuel to air ratio is rich or low excess air.

15. The combustion turbine of claim 14, wherein a portion of said exhaust gas exiting from said expansion turbine re-circulates to said compressor intake to provide a lower oxygen level in said combustion chamber.

16. The combustion turbine of claim 1, wherein said combustion turbine is connected to use post-combustion NOₓ control techniques to further reduce emissions.

17. The combustion turbine of claim 16, wherein said post-combustion NOₓ control techniques include selective catalytic reduction of NOₓ and selective non-catalytic reduction of NOₓ.

18. The combustion turbine of claim 16, wherein said combustion turbine is connected to use CO reduction catalysts to further reduce emissions.

19. The combustion turbine of claim 16, wherein said combustion turbine is connected to reduce CO via firing the expansion turbine exhaust gases in a waste heat boiler or in a duct burner.

20. The combustion turbine of claim 1, wherein said combustion turbine is fueled with gas, oil, hydrogen, synthetic fuels, coal-derived fuels, aviation fuels, solid fuels or a combination of these fuels.

21. The combustion turbine of claim 1, wherein said combustion turbine is stationary.

22. The combustion turbine of claim 1, wherein said combustion turbine is mobile.

23. The combustion turbine of claim 1, wherein said combustion turbine uses measurements of the temperature, plus the concentration of CO, O₂, or CO and O₂, at given locations within said combustion turbine to control the combustion process.

24. A method of operating a combustion turbine, comprising the steps of:
compressing a volume of air in a compressor;
directing the compressed air from said compressor into a first combustion chamber;
adding fuel to said first combustion chamber in an amount greater than can be completely combusted by available oxygen in the air; and
directing gases from said first combustion chamber into a first expansion turbine.

25. The method of claim 24, further comprising completing combustion of the fuel after the fuel leaves said first combustion chamber.

26. The method of claim 24, further comprising the step of adding additional air to said expansion turbine so that combustion can be completed in said turbine.

27. The method of claim 24, further comprising the step of adding additional air to said expansion turbine so that combustion can be continued in said expansion turbine.

28. The method of claim 24, wherein said first combustion chamber bums fuels with higher fuel bound nitrogen without significant increase in NOₓ emissions from said combustion turbine.

29. The method of claim 24, further comprising the steps of:
adding air to exhaust gases from said first combustion chamber;
directing exhaust gases from said first expansion turbine into a second combustion chamber; and
directing exhaust gases from said second combustion chamber into a second expansion turbine.

30. The method of claim 24, further comprising the step of:
adding steam, water or atomized water to said first expansion turbine.

31. The method of claim 24, further comprising the steps of:
capturing remaining heat in gases exhausted from said combustion turbine; and
using said captured heat to raise the temperature of gases prior to input to said combustion chamber.

32. The method of claim 24, further comprising the step of removing excess heat from the air in said first compressor.

33. The method of claim 24, further comprising the step of re-circulating a portion of exhaust gases from said first expansion turbine into an intake of said compressor.

34. The method of claim 33, where an after-cooler cools the recirculated gases.

35. The method of claim 24, further comprising the step of utilizing post-combustion NOₓ control techniques on gases exiting said expansion turbine.

36. The method of claim 24, further comprising the step of using selective catalytic reduction of NOₓ, and selective non-catalytic reduction of NOₓ, as post combustion NOₓ control technique.

37. The method of claim 24, further comprising the step of using CO reduction catalysts to further reduce emissions.

38. The method of claim 24, further comprising the step of firing the expansion turbine exhaust gases in a waste heat boiler or in a duct burner to reduce CO.

39. A method of constructing a combustion turbine comprising a compressor, a combustion chamber, and an expansion turbine, said method comprising the step of
constructing a combustion chamber or an expansion turbine using materials that are acceptable for operation in a non-oxidizing, high-temperature atmosphere.

40. The method of claim 39, wherein said constructing step uses materials that are acceptable for operation in a non-oxidizing atmosphere at temperatures above 1,500° F.
